(19) United States
(12) Patent Application Publication
(10) Pub. No.: US 2014/0304600 A1
(43) Pub. Date: Oct. 9, 2014

(54) SYSTEMS AND METHODS FOR IDENTIFYING OBJECTS

(71) Applicant: Miyoko Chu, Ithaca, NY (US)

(72) Inventor: Miyoko Chu, Ithaca, NY (US)

(73) Assignee: Cornell University, Ithaca, NY (US)

(21) Appl. No.: 14/352,823

(22) PCT Filed: Oct. 19, 2012
(86) PCT No.: PCT/US2012/061155

§ 371 Date: Apr. 18, 2014

Related U.S. Application Data
(60) Provisional application No. 61/552,920, filed on Oct. 28, 2011.
(60) Provisional application No. 61/548,892, filed on Oct. 19, 2011.

(51) Int. Cl. G06F 3/0481

(52) U.S. Cl. CPC G06F 3/0481
USPC 715/716; 715/751

(57) ABSTRACT

System and methods for providing and organizing information related to an object. Certain embodiments are directed to permitting a user to identify an object given certain observable characteristics about the object, but generally not all of the characteristics about the object. The identification may occur by comparing user-provided information with dynamically updated stored information.

### PRIORITY CLAIM

This application claims the benefit of U.S. Provisional Application No. 61/548,892 filed Oct. 19, 2011 and U.S. Provisional Application No. 61/552,920 filed Oct. 28, 2011.

### STATEMENT CONCERNING U.S. GOVERNMENT SPONSORED RESEARCH

This invention was made with U.S. government support under grant DRL-1010818 awarded by the National Science Foundation. The U.S. government has certain rights in the invention.

### FIELD OF THE INVENTION

The present invention relates generally to systems and methods of identification, and, more specifically, to identification (“ID”) tools for identifying an object by receiving information about the object and comparing that information to information obtained dynamically from one or more sources.

### BACKGROUND OF THE INVENTION

From time to time, a person may observe an object, hear a sound emitted by an object, or otherwise gather or perceive some information about an object. For the purposes of this application, an “object” can be any identifiable item, including any type of organism or non-organismal item and the information which the observer observes, hears, gathers, or otherwise perceives about the object shall be termed “user information” or “user-provided information”. Upon perceiving the object, the observer—that is, the one who perceives information about an object—may wish to consider, review, and otherwise learn additional or other information about the object which the observer may not have personally observed, heard, gathered, or otherwise perceived (“non-user-provided information” or “information”). If the observer knows the name of the object, the observer may look for such additional information using the name of the object, for example, in resource organized generally alphabetically by object name, such as an encyclopedia or almanac. However, if the observer does not know the name of the object or only knows a general name and not a specific name, obtaining information about the object may be a time consuming and labor intensive process.

One technique for finding information about an object is to access a resource, such as a book or website that includes many labeled images of objects. An observer may skim or scroll through a large assortment of images in an attempt to match that which the observer perceived with a labeled image. Sometimes such books or websites are categorized by type of object, e.g., genus or species of an organism, shape of an object, color of an object, or other. However, manually reviewing such large assortment of images can be time consuming and overall inefficient.

In another technique, an observer may search, for example, for information using the observable characteristics of the object. For purposes of this application, the term “characteristic” means not only features of an object, such as size, color, luster, texture, shape, surface area, etc., but also information related to the object such as environmental information or other context information. For example, characteristics may include the sound or sounds generated by the object, type or quantity of food consumed or metabolized by an organismal object, geographic location of the object, location of the object relative to other objects, time of day of object observation, or time of year of object observation.

In one conventional from of characteristic-based searching, an observer may refer to a traditional classification resource such as an identification key. An identification key, such as a dichotomous key or a polytomous key, offers a fixed sequence of identification steps, in which each step offers multiple alternatives, the choice of which determines the next step. An example of a simplified key for object identification of trees is provided below.
1. If the tree has leaves, proceed to step 2. If the tree does not have leaves, proceed to step 3.
2. Proceed to separate key for leaf trees.
3. If the tree has needles, proceed to step 4. If the tree does not have needles, proceed to step 5.
4. The tree is likely to be a pine tree.
5. The tree is likely to be a fern tree.

Keys may be helpful for certain classification tasks but often have a number of limitations associated with them. For example, a novice observer may not understand the terms used in each question which forms the key. In addition, even trained observers may not have been able to observe every characteristic in the key or may not recall every characteristic in the key. Other characteristics may be difficult to define or perceived differently by each observer. Clearly, a key has limited applicability for classification tasks.

Another conventional procedure for characteristic-based searching about an object may include doing a search in a search engine with access to an electronic field guide, electronic encyclopedia, or other information resources on a network such as the Internet. Typically, such search engines may permit an observer to access a wide variety of information that is generally more extensive than that available in a printed encyclopedia or almanac. In addition, search engines often permit an observer to enter a search request in free form, so the observer does not need to know the specific vocabulary already present in an identification key.

However, certain disadvantages are associated with search engines. Specifically, search engines often employ machine-learning techniques, e.g., decision tree or support vector machine, in generating the search results. While such techniques have been found to be accurate when the observer enters precise, complete, and expert-level descriptors, many observers may not know the precise, complete, expert-level “terms of art” in the field of the object. Often, words and methods that experts use to identify objects differ from the words and methods used by novices. There is often a disconnection between public and expert perception and vocabulary in both visual and audio descriptions of objects. Accordingly, the search engine often does not produce an accurate match for the search conducted by the observer.

An additional procedure for obtaining information about an object may include doing a search of records. To search, the observer may enter a search request in the form of a text, an image, or a sound bite. If the certain search request is presented in the form of an image or sound bite, the need for the observer to know specific terms of art in the field of the object may advantageously be avoided.

However, despite the benefits of broader search requests, many disadvantages are associated with such records. For example, records are often rigidly structured, which may limit the accuracy of the search results. Also, records are typically static or updated only sporadically. Accordingly, the information stored in records may become outdated quickly in fast-moving research fields. Even with respect to records for slow moving research fields, it is often unclear when updated information was added to the record.

Another technique for obtaining information about an object is an object-identifying apparatus configured to store information about a specific object. Like records, such apparatus-stored information may also be generally static or updated sporadically. In addition, the apparatus-based technique is also limiting in that a user must purchase the object-identifying apparatus, which is typically usable only for object-identification.

Clearly, there is a demand for a system and method for obtaining object information based on searching a wide variety of novice-level through expert-level characteristics and dynamically updating the object information records accessible on a multi-purpose device. The present invention satisfies this demand.

### SUMMARY OF THE INVENTION

The present invention is directed to a system and methods for permitting a person to obtain information about an object. Certain embodiments are directed to facilitating identification of an unknown object in which certain characteristics about the object are known.

For purposes of this application, certain embodiments of the present invention are discussed in reference to identification of birds, but the discussion is merely exemplary. The present invention is applicable to identification of any type of object.

Birds are generally easy to observe for people in rural, urban, and suburban environments. Many people actively engage in bird watching or passively observe birds at a bird feeder or in birds' natural habitats. Many bird species are endangered or threatened. As people improve their knowledge of and appreciation for birds, more may be done to protect them.

The system and methods of the present invention are configured to permit a user to obtain information about birds. Embodiments of the present invention include one or more system modules. In certain embodiments, information may be exchanged between modules generally in real time, such that the information available in the modules is updated regularly and benefits from the information received by each other module. Specifically, crowd sourced submission—that is, any information, including text, recorded sounds, recorded videos, or images provided to the system by the user—may be used to improve and expand stored information. In addition, learning algorithms may be utilized to enhance search results and bird identification processes. The recorded sounds may occur naturally or may be man-made.

Examples of system modules include an information storage module, identification module, activity module, viewing module, submission module, information export module, and user-messaging module.

Embodiments of the information storage module may include a database or other information storage medium configured to store information, including characteristics about birds. The information storage module will also be termed an “information module” and a “bird information module”. The bird information module may be built using information from expert sources, other databases, research tools, other modules according to the present invention, and publications, including, for example, peer reviewed journals, text books, aviary reports, and field guides.

In certain embodiments, the bird information module has a species profile for one or more species of birds. Certain embodiments may have species profiles for a group of species from a specific region, while other embodiments may not be limited by geographic region. A species profile may include name characteristics, identification characteristics, life history characteristics, sound characteristics, video characteristics, and narrative information.

Name characteristics may include common name, scientific name, higher-level scientific classifications, and alternative names.

Identification characteristics may include one or more representations, such as images, photos, drawings, or depictions, description of the visual characteristics of the bird (including, for example, separate descriptions of adult and juvenile, and male and female birds, where relevant), graphical display of geographic migration patterns or geographic range of species, and information regarding any subspecies identification information.

Life history characteristics may include information about measurements, habitat, food, nesting, behavior, and conservation status. Life history characteristics also may be displayed using symbols. Symbols may include any representation, alpha-numeric character, or indicator configured to convey information about the life history. Certain simplified symbols may be configured to permit the user to quickly and easily perceive the information in the symbol. For example, food information may be conveyed using a simplified representation of an insect for insectivores, representation of a plant for an herbivore, and representation of an insect and a plant for omnivores. Habitat information may be conveyed using a simplified representation of a forest (e.g., multiple trees), open woodland (e.g., one tree with several bushes), grassland (e.g., tall grass), or lake/pond (e.g., water).

Sound characteristics may include a text description of the auditory emissions generally made by a species and may include a sound recording that permits the user to hear an example sounds made by the species', e.g., the bird's call.

Video characteristics may include a video or other audio-visual media that may be played for the user and a text description of the same.

Narrative information includes information related to how people of different bird-watching or bird researching skill levels describe birds and their characteristics. Narrative information records may include specific examples of terms or colors used by a person to describe a specific bird, specific observation, specific image, or specific video. Narrative information also may include information regarding the person's skill level related to birds, education level, age (e.g., exact age or age range such as, child, teenager, or adult), primary spoken language, regional dialect, cultural dialect, and other information relevant to word choice in describing birds or bird characteristics.

In addition to a species profile, certain bird information modules may include a genus profile, family profile, order profile, class profile, phylum profile, or kingdom profile. Each profile may include identification information regarding the objects in that category. In embodiments directed to objects other than organisms, the information module may include profiles for any type or number of classification levels.

Another module in certain embodiments of the present invention is a bird identification module. Certain embodiments of the bird identification module include a general search field in which a user may provide text search terms regarding a bird about which the user wishes to obtain certain information. In other embodiments, the user may provide non-text search parameters such as a representation, sound recording, or video. Embodiments of the bird identification module also may include a query and answer component configured to permit entry of selected information most likely to obtain relevant bird information.

An additional module in certain embodiments of the present invention is a bird activity module. A bird activity module includes games or activities related to birds. Certain activities are configured to permit requesting specific information about birds, how a user describes a bird, bird image, or bird video, how a user interacts with birds, or other information regarding how a user perceives certain birds. Such activities may be beneficial in research settings and may replace or augment conventional survey methods. Other activities are configured to facilitate user learning about birds. In certain embodiments, games and activities may permit the user to earn points that unlock higher-level games or opportunities for prizes.

Another module in certain embodiments of the present invention is a bird viewing module. The bird viewing module is configured to permit a user to view certain information stored in the bird information module. The bird viewing module may be configured to provide certain viewing experiences, for example, permitting the user to view certain groups of birds as categorized by region, classification, or user interest.

An additional module in certain embodiments of the present invention may include a bird information submission module. Such module is configured to permit users to submit information for addition to the bird information module. While other modules of the invention may permit entry and submission of user information that will eventually be added to the bird information module, the bird information submission module is specifically configured for this purpose. A user may submit a complete text description of a bird sighting, a partial text description of a bird sighting, a representation of a bird, research information about a bird, or other information that they wish to contribute to the bird information module. Where applicable, the user may also provide a copyright license or assignment to permit copying and distribution of the submission in the system and methods.

An additional module in certain embodiments of the present invention is an information export module. An information export module is configured to permit the user to export information from the system to an external element. An external element may be a physical device or device output such as a printer, fax machine, or scanner, and related output.

An external element also may include a social network program, such as Facebook, LinkedIn, Twitter, Flickr, a blog, or other such program known in the art. A user may export, for example, a notice of submission to the system, a notice of activity completion, or bird information about which the user provides comments or wishes to highlight.

Also, an external element may include another type of software program or computer application. For example, certain embodiments may be configured for educational uses and a user may export activity scores or browsing time to an educational tracking program. In another example, the user may export a subset of bird information into a spreadsheet document, a word processing document, an image document, an electronic mail document, or other information organizational output.

Another module in certain embodiments of the present invention is a messaging module configured to permit one or more users to send and receive messages to one another through the system and methods.

Certain embodiments of the present invention include a user interface configured to permit a user to access the system modules. A user interface may include a selective access element that permits control over access to the modules. The selective access element may require a user to provide certain personal information and create a user name and password in order to gain access to the system modules. The system may store personal information for later sessions or delete personal information after a session is over. In such embodiments, the personal information file may include information about the user such as the user's age, residence, skill in identifying birds, common spoken language, etc. Such personal information may be permanently stored by the system and capable of being edited by the user. Based on such personal information, the system modifies the queries. For example, queries may be based on the skill of the user. Queries also may be provided in the native language of the user. The system provides queries to the user after the user completes the log in procedure.

An administrative user may have the right to make certain changes to the system that a non-administrative user would not have. In other embodiments, at least certain modules are accessible through a user interface without providing personal information or signing in.

Embodiments of the present invention also may be configured to communicate with physical devices. For example, a user interface may be configured for a specific type of display unit. Various modules may be configured to communicate with a context device, such as a global positioning unit, configured to provide information such as location or reference point of the user. Various modules may be configured to communicate with a time detection device configured to detect time and communicate with the other modules of the system. Various modules may be configured to communicate with an audio management device may be configured to capture and communicate sounds or sound recordings. Various modules may be configured to communicate with a video management device configured to capture and communicate audio-visual material such as audio-visual recordings. The information provided by the physical devices may be incorporated into the identification process automatically such that the user does not have to input them. Advantageously, user error is avoided and information accuracy is improved.

In addition, algorithms known in the art may be used to analyze the device-generated system inputs. For example, such algorithms may extract metadata from the videos, images or other multi-media submissions. For the purposes of this application, the term “metadata” may include “submitted metadata” and “system metadata”. Submitted metadata is provided within a crowd sourced submission—including, by not limited to, the information associated with a photo, video, or sound recording uploaded to the system. System metadata is added by the system to a crowd sourced submission—including, but not limited to, the system added information associated with a photo, video, or sound recording uploaded to the system.

In another embodiment, the system could incorporate systems using audio recordings to identify bird species, enabling users to upload a bird recording and learn the species of the bird. In each of the embodiments described in this application, the system may process image, video, or sound recordings uploaded through a mobile device or the Internet from a client host or other input device. Moreover, it is contemplated that the records to be uploaded to the system may be pre-processed by mobile applications or other algorithms prior to uploading to the system to aid in the identification of the object.

In certain embodiments, a user may interact with the system to improve their efficiency and accuracy in identifying sounds generated by objects. A user may view a spectrogram of a sound recording and select a sound of interest from the spectrogram to assist with identification of the sound. The system may generate one or more queries about the selected sound and use any responses to the one or more queries to narrow the sound classification (e.g., “long; low” versus “sweet; high-pitched; trill”). The system also may provide other similar sounds or spectrograms and ask the user to select which one or ones are most similar to the sound that the user is trying to identify. In certain embodiments, the system may use metadata associated with the image, video, or sound recording, such as location or date, to determine the most likely species. The system may use machine learning algorithms to match data from images, video, or sounds with those from known objects. The system also may query the user for additional information, such as answering questions about color and other characteristics of the bird in the image or photo, or indicating the location of the head, back, or other body parts by clicking on the photo. This information may aid the system in matching the image, video, or sound to other images, videos, or sounds of the same or similar species in the database. The image, video, or sound recording may be stored in the system and the associated information or metadata used dynamically to improve the identification capabilities of the system. At the end of the interaction, the system presents images, videos and/or sound recordings of the most likely species from the database and asks the users which, if any, of the images, videos, or sound recordings match the same species that the user uploaded. The system may be configured to provide online bird identification and interactive exhibits.

By using dynamic information about bird locations and time of year, and incorporating algorithms to guide the query and answer process, the systems and methods may be more accurate than existing tools. The present systems and methods may use a dynamic database to arrive at the most likely species possibilities based on time and location—before any additional queries are asked about the bird's physical attributes.

One object of certain embodiments of the present invention is to provide a system and methods for object identification for users of a wide variety of experience levels.

Another object of certain embodiments of the present invention is to provide a system and methods configured to dynamically update object information database.

Another object of certain embodiments of the present invention is to compare user-provided information dynamically updated information.

Another object of certain embodiments of the present invention is to provide a system and methods configured to utilize user queries and user submissions to update object information database.

Another object of certain embodiments of the present invention is to provide a system and methods configured to crowd source the tasks related to object identification queries.

Another object of certain embodiments of the present invention is to provide a system and methods configured to permit users to learn about objects.

Another object of certain embodiments of the present invention is to provide a system and methods configured to permit users to learn about object identification and detail oriented observation.

Another object of certain embodiments of the present invention is to provide a system and methods configured to encourage users to play games related to objects.

Another object of certain embodiments of the present invention is to provide a system and methods configured to permit more than one user to connect with other users through such embodiments.

Another object of certain embodiments of the present invention is to provide a system and methods configured to permit a user to share information about its use of the system and methods via external social networking systems.

Another object of certain embodiments of the present invention is to provide a system and methods configured to permit users to play games related to identifying bird species.

Another object of certain embodiments of the present invention is to provide a system and methods configured to permit users to play games related to identifying colors in images of birds.

An additional object of certain embodiments of the present invention is to provide a system and methods configured to permit users to crop a bird image with a cropping tool such that the system learns over time how to identify birds in an electronic image automatically, without user intervention.

An additional object of certain embodiments of the present invention is to provide a system and methods configured to permit users to describe a bird image such that the system learns over time how people of various regional origins, cultural origins, and skill levels describe the same image.

An additional object of certain embodiments of the present invention is to provide a system and methods configured to permit users to describe a sound recording such that the system learns over time how people of various regional origins, cultural origins, and skill levels describe the same sound recording.

An additional object of certain embodiments of the present invention is to provide a system and methods configured to permit users to describe a video recording such that the system learns over time how people of various regional origins, cultural origins, and skill levels describe the same video recording.

An additional object of certain embodiments of the present invention is to provide a system and methods configured to permit users to view a plethora of bird images, listen to a plethora of bird recordings, and obtain context information about birds, all from one source.

An additional object of certain embodiments of the present invention is to provide a system and methods configured to be integrated into educational curriculum.

The present invention and its attributes and advantages may be further understood and appreciated with reference to the detailed description below of one contemplated embodiment, taken in conjunction with the accompanying drawings.

### DESCRIPTION OF THE DRAWINGS

FIG. 1A and FIG. 1B illustrate embodiments of a system according to the present invention.

FIG. 2 illustrates an embodiment of an information storage module.

FIG. 3 illustrates a method embodiment according to the present invention.

FIG. 4 illustrates a method embodiment according to the present invention.

FIG. 5 illustrates an embodiment of an information storage module.

FIG. 6 illustrates an embodiment of an exemplary computer system.

FIG. 7 illustrates an embodiment of an exemplary cloud computing system.

FIG. 8 illustrates an embodiment of a system according to the present invention.

FIG. 9A through 9D illustrate an embodiment of various user interface screens for bird identification.

FIG. 10 illustrates an embodiment of user interface screens for a first activity according to the present invention.

FIG. 11A through FIG. 11D illustrate an embodiment of user interface screens for a second activity according to the present invention.

### DETAILED DESCRIPTION OF THE INVENTION

Embodiments of the present invention are configured to permit a person to obtain information about an object. Certain embodiments are directed to facilitating identification of an unknown object in which certain characteristics about the object are known. An example of such embodiments are those directed to identifying information about a bird.

Generally, the identification tools described in this application may receive information about an object and dynamically compare that information to information obtained by one or more third party information from expert sources as well as crowd sourced submissions gathered through use of one or more of the tools. Accordingly, the ID tools may produce a classification system that can more accurately interpret varied responses from users than would be possible with systems limited to static or sporadically updated third party submission data from expert sources.

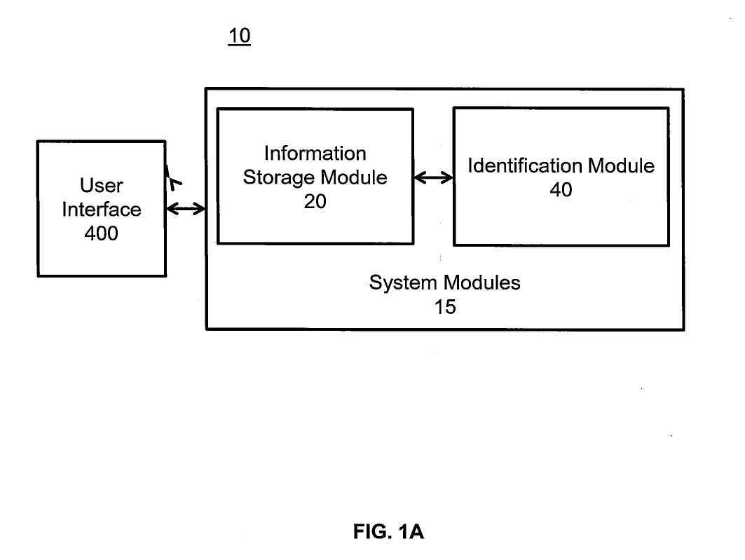

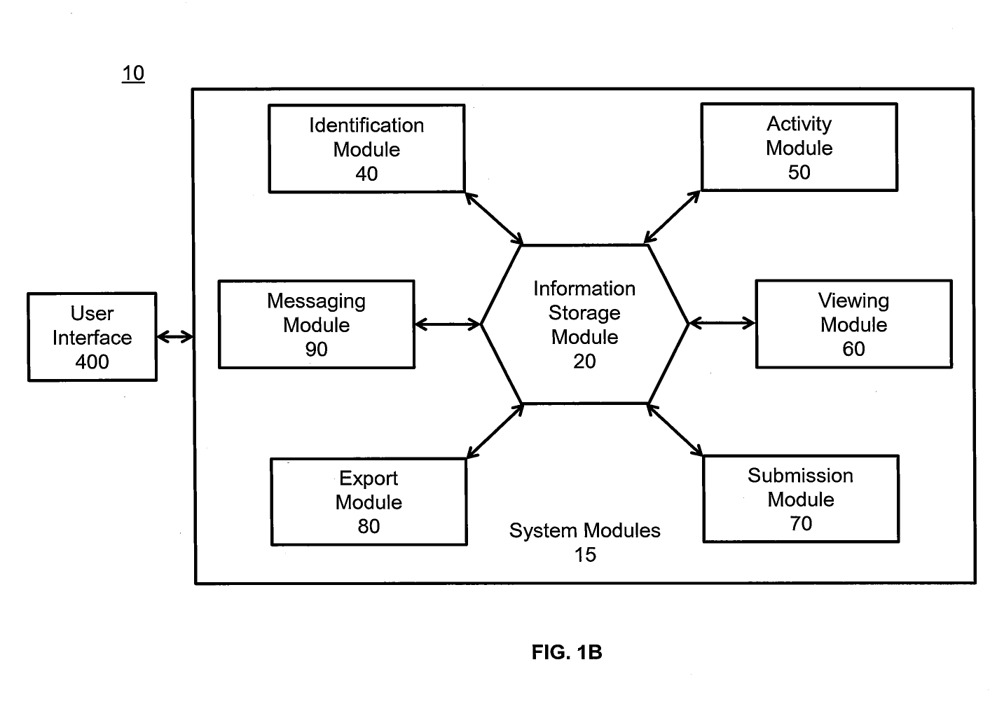

Embodiments of the present invention include one or more system modules 15. Preferred embodiments of the system modules 15 include at least an information storage module 20. As illustrated in FIG. 1A, certain embodiments may include an information storage module 20 and an identification module 40. As illustrated in FIG. 1B, other embodiments optionally include an activity module 50, viewing module 60, submission module 70, information export module 80, and user-messaging module 90. In other embodiments, the information storage module 20 is paired with only the activity module 50, viewing module 60, or submission module 70. Still other embodiments include other combinations of system modules 15.

As illustrated in FIG. 1A and FIG. 1B, information may be exchanged between modules. Although the information storage module is the central module through which all communication takes place and other modules are in a peripheral position in FIG. 1B, in other embodiments, each module can communicate directly with all other modules. The information exchange may occur generally in real time to distribute the most updated information or at discreet times in order to maximize efficiency.

Embodiments of the information storage module 20 may include a database or other information storage medium configured to store information, including characteristics about birds. The information storage module will also be termed an “information module” and a “bird information module”. The bird information module 20 may be built using information from expert sources, other databases, research tools, other modules according to the present invention, and publications, including, for example, peer reviewed journals, text books, aviary reports, and field guides.

In certain embodiments, the bird information module 20 has a species profile for one or more species of birds. Certain embodiments include information organized in profile units 22. For example, a profile unit for birds may include a species profile unit 22. A species profile unit 22 may include name component 24, identification component 26, life history component 28, sound component 30, video component 32, and narrative component 34. In addition to a species profile unit 22, certain bird information modules 20 may include a genus profile, family profile, order profile, class profile, phylum profile, or kingdom profile.

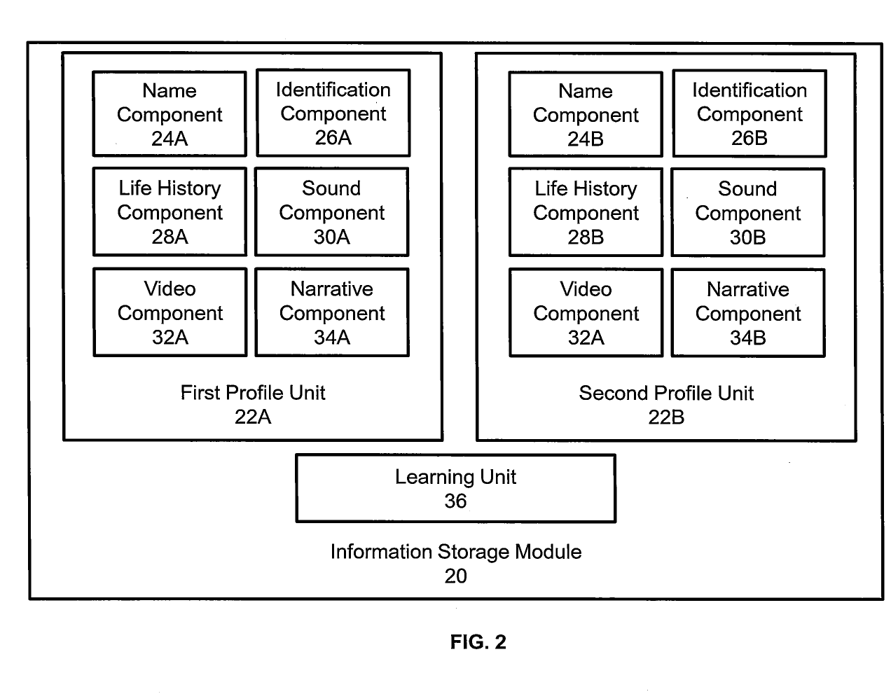

Although FIG. 2 includes a first profile unit 22A and a second profile unit 22B, a bird information module 20 may include any number of profile units and generally includes many, many profile units.

A bird information module 20 also may include a learning unit 36 configured to receive and learn from newly added information.

The system 10 overall seeks to solve the problem of identifying a category (species) of an object (bird) given observed or other known, but incomplete, characteristics of the object and given a large database of information. In other words, a user typically has observed characteristics or a few other known characteristics about a bird. Accordingly, using such known characteristics, which are generally not complete, the system and methods are configured to identify the bird species.

This identification problem may be solved by taking one or another general approach. One approach calls for input of the characteristics and output of the matching species identification, which has a cost of answering questions. Another approach presents all species identifications and the user reviews them until the desired species is found, which requires a review of photos or other species descriptions. Embodiments of this invention combine these approaches by calling for input of characteristics of the categories, then at the most efficient time, presenting species information for one or more species for the user to review.

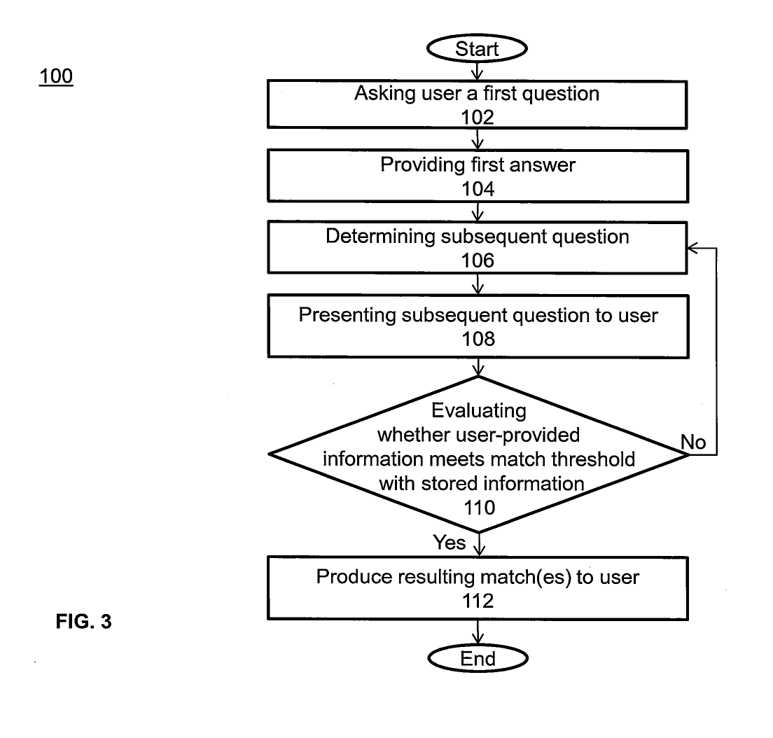

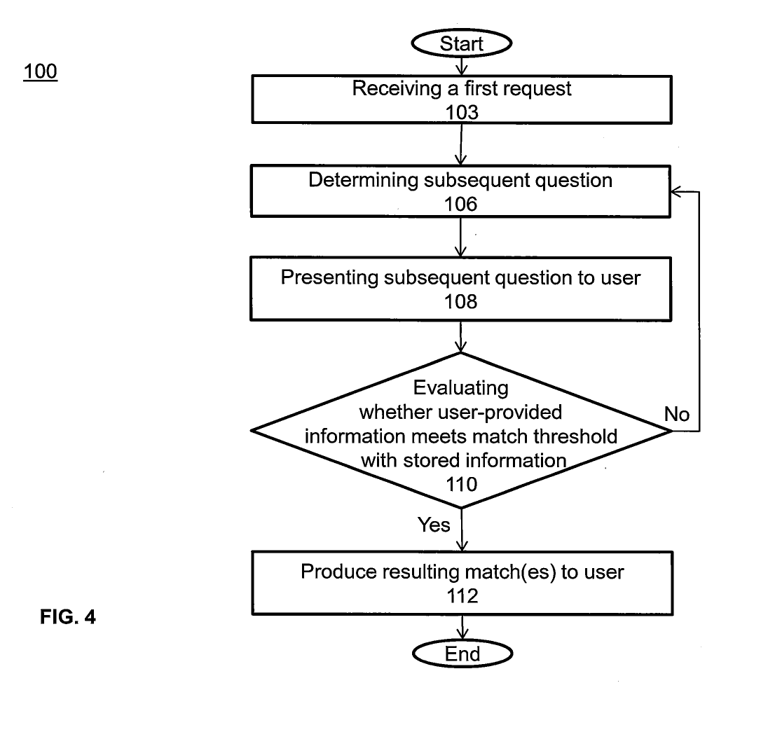

Embodiments of methods 100 according to the present invention are illustrated in FIG. 3 and FIG. 4. First, in a method embodiment 100, a user provides some information to the system. The initial request information may be provided either in response 102 to a first question 104 or in the form of entering search parameters 103. Specifically, an initial request may include text, image, sound recording, video, or other multimedia.

Next, the system assesses the user-provided information. Generally, such an assessment includes scoring each species to determine the probability that the species is the most accurate result according to the user-provided information. This results in a list of species ranked by score. Each time the system receives new information, the system re-scores and re-ranks the species list.

Then, the system determines what material should be presented to the user next 106—e.g., another question about a characteristic 108 or a ranked list of species 112. In this step, an expected cost of scanning the ranked list of categories is computed. The minimum cost characteristic—that is, the characteristic that, if known, would reduce the expected cost the most—is found. If no characteristic results in a reduction of expected cost, the system produces the ranked list of all species that match the user-provided information for review by the user. If a minimum cost characteristic is found, the system presents a question regarding the minimum cost characteristic to the user.

Upon receipt of the answer to the first minimum cost characteristic, the system rescores the species list, computes the expected cost of scanning the ranked list again, and again evaluates what materials should be presented to the user 110. The rescoring, cost determination, and evaluation steps are repeated until the cost determination is sufficiently low, a ranked list is provided to the user 112, or an upper limit of iterations is reached.

Embodiments of this method are configured to be executed quickly or at least at a user-friendly pace. Many conventional methods would require a user to wait too long while the information is being processed in between steps or would provide poor quality results.

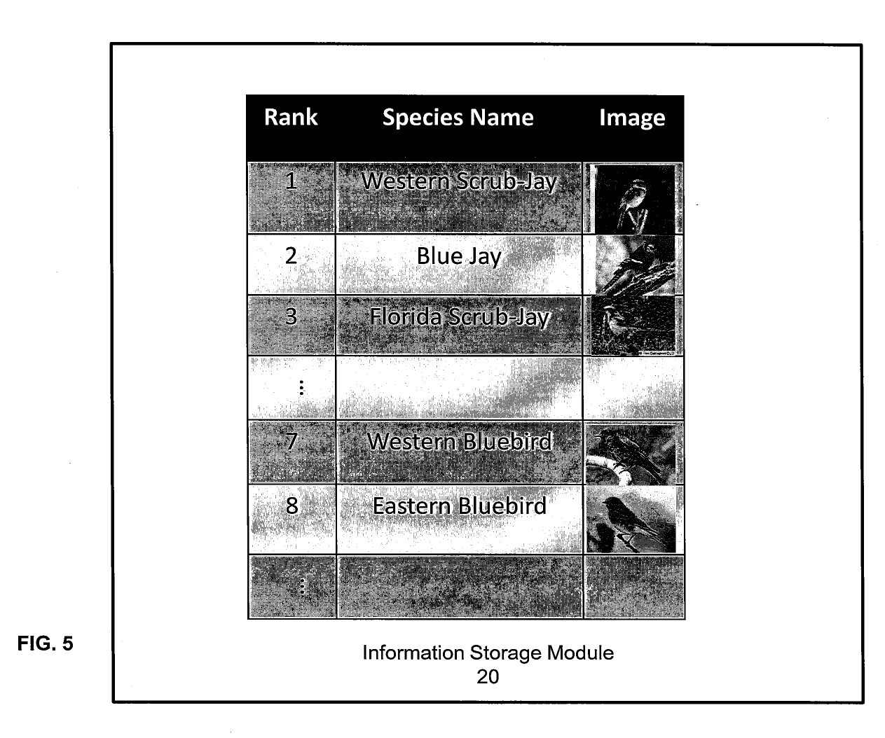

More specifically, to minimize the total identification cost, a computation is done to find A′⊂A, such that:

$${A}^{′} = argmin \{ {\sum }_{n ∈ {A}^{′}} {φ}_{att} ( a ) + {\sum }_{c ∈ C : s ( c ) \geq s ( {c}^{*} )} {φ}_{cat} ( c ) \} \qquad ( 1 )$$

wherein, c* is the true category, A is the set of all characteristics, φₐₜₜ(a) is the cost of answering about the characteristic, φ_{cat}(c) is the cost of scanning all the species categories, s(c) is the score of the category. For example, A′ may be color and size. The user enters blue color and size of small-medium. Out of an example database 20 of FIG. 5, then,

$$\begin{matrix}∀ a ∈ A : {φ}_{att} ( a ) = 1 & ( 2 ) \\ ∀ c ∈ C : {φ}_{cat} ( c ) = 1 & ( 3 ) \\ {\sum }_{a ∈ {A}^{′}} {φ}_{att} ( a ) + {\sum }_{c ∈ C : s ( c ) \geq s ( {c}^{*} )} {φ}_{cat} ( c ) = 2 + 8 = 10 & ( 4 )\end{matrix}$$

and, c* is the Eastern Bluebird.

Then, a question about chest color is asked. The user identifies chest color as brown. Given a chest color of brown,

$$\begin{matrix}∀ a ∈ A : {φ}_{att} ( a ) = 1 & ( 5 ) \\ ∀ c ∈ C : {φ}_{cat} ( c ) = 1 & ( 6 ) \\ {\sum }_{a ∈ {A}^{′}} {φ}_{att} ( a ) + {\sum }_{c ∈ C : s ( c ) \geq s ( {c}^{*} )} {φ}_{cat} ( c ) = 3 + 2 = 5 & ( 7 )\end{matrix}$$

and, c* is the Eastern Bluebird.

Clearly, the variable c* is the unknown. If user scans c*, she can identify it as the true species (and the match to the observed bird). The number of scanned species depends on the position of c* in the ranked list. The variable c* can be in any position. Then, the expected species cost over all species in C.

$${A}^{′} = argmin \{ {\sum }_{n ∈ {A}^{′}} {φ}_{att} ( a ) + {\sum }_{c ∈ C} [ P ( C = c \vert {⋀}_{a ∈ {A}^{′}} {R}_{a} = {r}_{a} ) {\sum }_{{c}^{′} ∈ C : s ( {c}^{′} ) \geq s ( c )} {φ}_{cat} ( {c}^{′} ) ] \} \qquad ( 8 )$$

Then, the list is sorted according to the score function:

$$s ( c ) = \frac{P ( C = c \vert {⋀}_{a ∈ {A}^{′}} {R}_{a} = {r}_{a} )}{{φ}_{cat} ( c )} \qquad ( 9 )$$

To solve, a classification method that outputs the probability that each species is the true species result. Any probability classification method can be used, for example, Bayes, decision trees, Laplace estimation method, or support vector machines, to name a few.

In utilizing Bayes, the rule becomes:

$$P ( C = c \vert {⋀}_{a ∈ {A}^{′}} {R}_{a} = {r}_{a} ) = \frac{P ( {⋀}_{a ∈ {A}^{′}} {R}_{a} = {r}_{a} \vert C = c ) P ( C = c )}{P ( {⋀}_{a ∈ {A}^{′}} {R}_{a} = {r}_{a} )} \qquad ( 10 )$$

In utilizing Naïve Bayes, the rule becomes:

$$P ( C = c \vert {⋀}_{a ∈ {A}^{′}} {R}_{a} = {r}_{a} ) = \frac{{\prod }_{a ∈ {A}^{′}} P ( {R}_{a} = {r}_{a} \vert C = c ) P ( C = c )}{{\prod }_{a ∈ {A}^{′}} P ( {R}_{a} = {r}_{a} )} \qquad ( 11 )$$

Another approach for efficiently obtaining probabilities that the user-provided information is compatible with the dynamically updated stored information regarding species is a modified bagged decision tree ensemble. Typically, the trees store probability predictions only in the leaf nodes. The modified trees for the present approach store such predictions in every tree node. This permits a return of “coarser-grained” probability estimates even without reaching the leaf nodes. In addition, certain embodiments may be run with a smaller parameter depth, which results in faster response time and lower accuracy in results. The parameter depth is controls how deeply each tree is explored. Also, in certain embodiments, another parameter tree-number, which controls how many trees of the bagged tree ensemble will be used for a prediction task. Smaller tree-numbers also result in faster response times and lower accuracy in results.

Certain sets of depth and tree-numbers permit highly accurate probability estimation during the bird identification process. Since larger depth and tree-number result in slower response time but usually better probabilities, a mechanism to automatically tune these two parameters may be used. The algorithm targets a response time just below a given threshold for interactive response time, e.g., 5 seconds, while the best possible probability estimates are obtained for this response time threshold from the model.

Overall, response time is measured for every user interaction and the response time will generally not increase unless the depth or tree-number is increased. As the user answers questions and more information is obtained, response time can actually decrease in successive question iterations. As the system detects such a decrease in time, the algorithm automatically increases depth and/or tree-number to maximize accuracy, accordingly. Embodiments of the present invention are configured to achieve near-interactive response times, while still finding the correct bird species with almost as little user effort as if the unmodified, slower algorithm had been used.

To compute the minimum cost characteristic, assume the user's responses are known, find the characteristics that reduce the total cost most. For example, in Naïve Bayes, for all subsets of A the space size is 2^{|A|}, or the space size is one attribute at a time. |A|

However, since the user's responses are not actually known, estimates are done. Under ideal circumstances, the user observes the characteristics under ideal conditions and the user is an expert who is capable of providing the true characteristics. However, the reality may be that the weather was poor, there was a short observation time, the user forgets some characteristics, or colors or size are subjective, and accordingly, the user provides imprecise size, shape, and color. Using classic classification methods for probability output, a probability of user selecting a specific answer is calculated.

In certain embodiments, the method also performs steps to alert user to the possible effects of an imprecise answer. An imprecise answer for the next minimum cost characteristic may cause cost O(1), which may mean no added information. However, if an imprecise answer causes the true species to be ranked poorly, the user must scan a lot of species categories at a cost O(n).

Clearly, incorrect and inaccurate user answers can result in poor probability estimates. For example, if a user first asserts that the observed bird was blue, but actually has seen a red bird, correct identification may be challenging.

To address such challenges, the method may include a step of examining the sensitivity of the current species ranking to the responses given by the user so far. From the sensitivity examination, the system may recognize the user-provider information that most strongly affected the species ranking and provide such information to the user. The user can then review the responses and possibly retract or modify them. For example, if the user was not very sure about the blue color, but still entered the information, our sensitivity response could tell the user that this choice had a strong impact on the species ranking. Being alerted to this issue, the user might decide to retract the color response and might suddenly see a more desirable ranking where a red bird, such as a Cardinal is ranked high.

Without the sensitivity analysis, existing approaches would try to determine if a user response differs significantly from what was expected based on historic searches and user responses so far. To do so, outlier detection techniques or errors as variables can be used a prediction model.

The examining sensitivity step is characterized more generally in the following. Let LC be the current species ranking computed by the algorithm and A be an attribute for which the user has revealed an answer. Furthermore, let R(A) denote the set of all alternative responses the user might have given to the question about A. The sensitivity of the current ranking LC to attribute A is defined as the maximum difference DIST(LC, L) between LC and any other ranking L that could be obtained if the user were to change the current answer for attribute A to any other value in R(A).

Distance between rankings can be measured in many ways, including for example, Minkowski distance or the number of inversions.

Another way to compute the sensitivity of an attribute A would be by trying all different answers in R(A), computing the new species ranking for each, and then finding the one that is most different from the current ranking.

However, since the user not only chooses possible characteristic values, but also assigns a level of certainty, the space of possible alternative responses in R(A) can be very large, preventing fast enough computation of sensitivity scores when using the “attempt all answers” algorithm.

To speed up sensitivity computation, a structural property that allows elimination of a large fraction of the possible answers in R(A) is used, while finding that the answer resulting in the greatest difference between rankings LC and L is not eliminated.

The system may learn about the common mistakes made by users or perception inconsistencies through the information obtained in the activities module and other historic data. Using such learned information, the system may make adjustments to the steps.

Certain embodiments also permit a user to designate a level of certainty about an answer to a question. If the user has a high level of certainty that the answer is correct, that characteristic is ranked higher than characteristics designated with a lower level of certainty.

In one embodiment of the system, a user can opt to view thumbnail images of a subset of birds before or after completion of a query and answer session. The system processes an answer, and may select an ultimate answer for the correct bird at any time. Within a predetermined maximum number of questions (e.g., 20) in certain embodiments, the system may present the user with its best guess or asks the user to pick from a final selection of photos. If the user selects “none of these is right,” then the system may display more photos, ask additional questions, or explain what missing information is needed to provide an ultimate answer. If the question and answer session is inconclusive, users can post a photo in a “Mystery Birds” section for other users to comment on and predict the bird species.

In another method embodiment, the first step may begin with a user entering an initial request, which typically includes search parameters. In other embodiments, the first step may begin with the system supplying a first question to the user. The user then answers the question. In either first step, the user provides some information—either in the form of a response to a question or in the form of search parameters. Then, the system assesses the user-provided information. Based on the assessment, the system determines an appropriate follow-up question and provides that question to the user through the user interface. The user answers the follow-up question and the system analyzes the answer to determine whether the user-provided information, including any initial request and answers match with any profiles in the information module. If a match is found and the match meets a match threshold, the system produces the result to the user. If no match is found or the match does not meet the match threshold, the system delivers a subsequent follow-up question. The answer is reviewed, a match evaluation done, and the steps are repeated until either a match is found or an upper limit of subsequent follow-up questions is reached.

After the first user process ends, the system stores the exchange. Then, the system identifies differences between user-provided information and information in the storage module, and attempts to improve the process for future users. If improvements can be made, such improvements are applied in subsequent searches or query/answer exchanges.

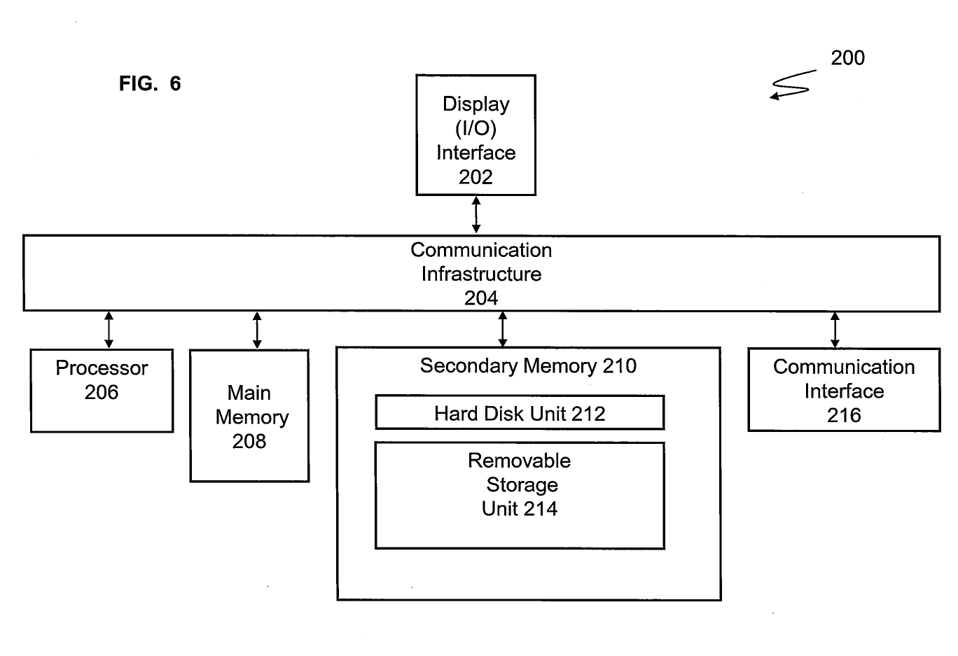

FIG. 6 illustrates an exemplary computer system 200 that may be used to implement the methods according to the invention. One or more computer systems 200 may carry out the methods presented herein as computer code.

Computer system 200 includes an input/output display interface 202 connected to communication infrastructure 204—such as a bus —, which forwards data such as graphics, text, and information, from the communication infrastructure 204 or from a frame buffer (not shown) to other components of the computer system 200. The input/output display interface 202 may be, for example, a keyboard, joystick, trackball, mouse, speaker, a display unit 99 such as a touchscreen or monitor, printer, any other computer peripheral device, or any combination thereof, capable of entering and/or viewing data.

Computer system 200 includes one or more processors 206, which may be a special purpose or a general-purpose digital signal processor that processes certain information. Computer system 200 also includes a main memory 208, for example random access memory (“RAM”), read-only memory (“ROM”), mass storage device, or any combination thereof. Computer system 200 may also include a secondary memory 210 such as a hard disk unit 212, a removable storage unit 214, or any combination thereof. Computer system 200 may also include a communication interface 216, for example, a modem, a network interface (such as an Ethernet card or Ethernet cable), a communication port, a PCMCIA slot and card, wired or wireless systems (such as Wi-Fi, Bluetooth, Infrared), local area networks, wide area networks, intranets, etc.

It is contemplated that the main memory 208, secondary memory 210, communication interface 216, or a combination thereof, function as a computer usable storage medium, otherwise referred to as a computer readable storage medium, to store and/or access computer software including computer instructions. For purposes of this application, a “computer readable storage medium” includes all non-transitory computer readable media. For example, computer programs or other instructions may be loaded into the computer system 200 such as through a removable storage device, for example, a floppy disk, ZIP disks, magnetic tape, portable flash drive, optical disk such as a CD or DVD or Blu-ray, Micro-Electro-Mechanical Systems (“MEMS”), nanotechnological apparatus. Specifically, computer software including computer instructions may be transferred from the removable storage unit 214 or hard disc unit 212 to the secondary memory 210 or through the communication infrastructure 204 to the main memory 208 of the computer system 200.

Communication interface 216 allows software, instructions and data to be transferred between the computer system 200 and external devices or external networks. Software, instructions, and/or data transferred by the communication interface 216 are typically in the form of signals that may be electronic, electromagnetic, optical or other signals capable of being sent and received by the communication interface 216. Signals may be sent and received using wire or cable, fiber optics, a phone line, a cellular phone link, a Radio Frequency (“RF”) link, wireless link, or other communication channels.

Computer programs, when executed, enable the computer system 200, particularly the processor 206, to implement the methods of the invention according to computer software including instructions.

The computer system 200 described herein may perform any one of, or any combination of, the steps of any of the methods presented herein. It is also contemplated that the methods according to the invention may be performed automatically, or may be invoked by some form of manual intervention.

The computer system 200 of FIG. 6 is provided only for purposes of illustration, such that the invention is not limited to this specific embodiment. It is appreciated that a person skilled in the relevant art knows how to program and implement the invention using any computer system.

The computer system 200 may be a handheld device and include any small-sized computer device including, for example, a personal digital assistant (“PDA”), smart hand-held computing device, cellular telephone, or a laptop or netbook computer, hand held console or MP3 player, tablet, or similar hand held computer device, such as an iPad®, iPod Touch® or iPhone®.

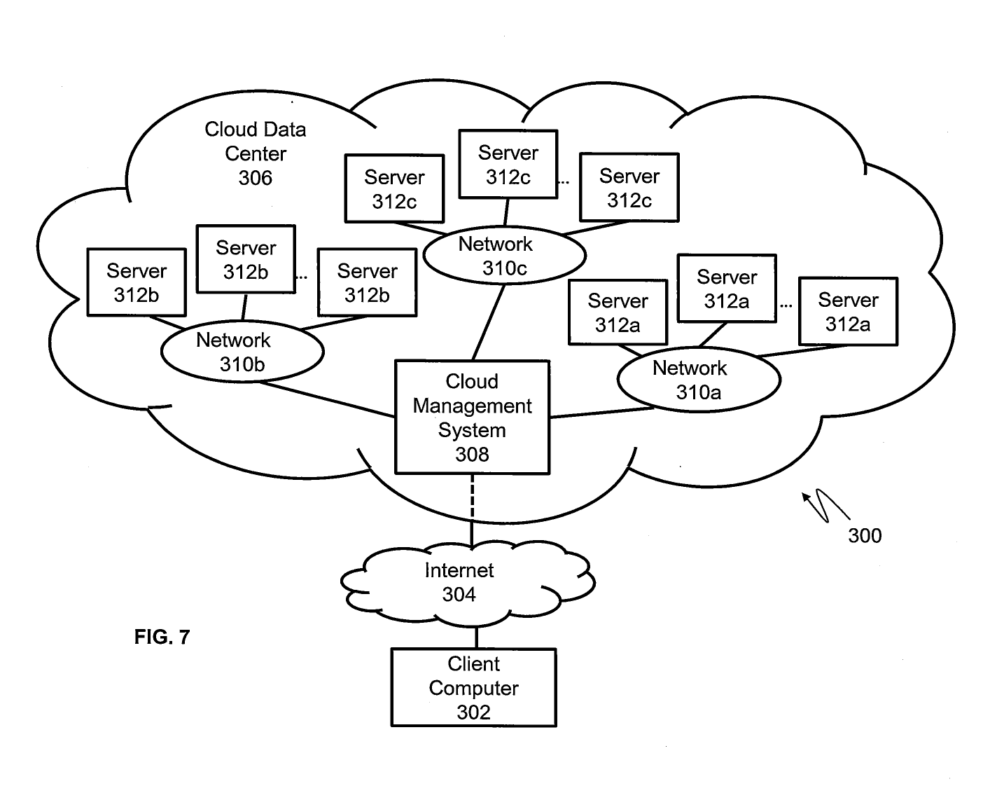

FIG. 7 illustrates an exemplary cloud computing system 300 that may be used to implement the methods according to the present invention. The cloud computing system 300 includes a plurality of interconnected computing environments. The cloud computing system 300 utilizes the resources from various networks as a collective virtual computer, where the services and applications can run independently from a particular computer or server configuration making hardware less important.

Specifically, the cloud computing system 300 includes at least one client computer 302 such as a computer system 200. The client computer 302 may be any device through the use of which a distributed computing environment may be accessed to perform the methods disclosed herein, for example, a traditional computer, portable computer, mobile phone, personal digital assistant, tablet to name a few. The client computer 302 includes memory such as random access memory (“RAM”), read-only memory (“ROM”), mass storage device, or any combination thereof. The memory functions as a computer usable storage medium, otherwise referred to as a computer readable storage medium, to store and/or access computer software and/or instructions.

The client computer 302 also includes a communications interface, for example, a modem, a network interface (such as an Ethernet card), a communications port, a PCMCIA slot and card, wired or wireless systems, etc. The communications interface allows communication through transferred signals between the client computer 302 and external devices including networks such as the Internet 304 and cloud data center 306. Communication may be implemented using wireless or wired capability such as cable, fiber optics, a phone line, a cellular phone link, radio waves or other communication channels.

The client computer 302 establishes communication with the Internet 304—specifically to one or more servers—to, in turn, establish communication with one or more cloud data centers 306. A cloud data center 306 includes one or more networks 310a, 310b, 310c managed through a cloud management system 308. Each network 310a, 310b, 310c includes resource servers 312a, 312b, 312c, respectively. Servers 312a, 312b, 312c permit access to a collection of computing resources and components that can be invoked to instantiate a virtual machine, process, or other resource for a limited or defined duration. For example, one group of resource servers can host and serve an operating system or components thereof to deliver and instantiate a virtual machine. Another group of resource servers can accept requests to host computing cycles or processor time, to supply a defined level of processing power for a virtual machine. A further group of resource servers can host and serve applications to load on an instantiation of a virtual machine, such as an email client, a browser application, a messaging application, or other applications or software.

The cloud management system 308 can comprise a dedicated or centralized server and/or other software, hardware, and network tools to communicate with one or more networks 310a, 310b, 310c, such as the Internet or other public or private network, with all sets of resource servers 312a, 312b, 312c. The cloud management system 308 may be configured to query and identify the computing resources and components managed by the set of resource servers 312a, 312b, 312c needed and available for use in the cloud data center 306. Specifically, the cloud management system 308 may be configured to identify the hardware resources and components such as type and amount of processing power, type and amount of memory, type and amount of storage, type and amount of network bandwidth and the like, of the set of resource servers 312a, 312b, 312c needed and available for use in the cloud data center 306. Likewise, the cloud management system 308 can be configured to identify the software resources and components, such as type of Operating System (“OS”), application programs, and the like, of the set of resource servers 312a, 312b, 312c needed and available for use in the cloud data center 306.

The present invention is also directed to computer products, otherwise referred to as computer program products, to provide software to the cloud computing system 300. Computer products store software on any computer useable medium, known now or in the future. Such software, when executed, may implement the methods according to certain embodiments of the invention. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, Micro-Electro-Mechanical Systems (“MEMS”), nanotechnological storage device, etc.), and communication mediums (e.g., wired and wireless communications networks, local area networks, wide area networks, intranets, etc.). It is to be appreciated that the embodiments described herein may be implemented using software, hardware, firmware, or combinations thereof.

The cloud computing system 300 of FIG. 7 is provided only for purposes of illustration and does not limit the invention to this specific embodiment. It is appreciated that a person skilled in the relevant art knows how to program and implement the invention using any computer system or network architecture.

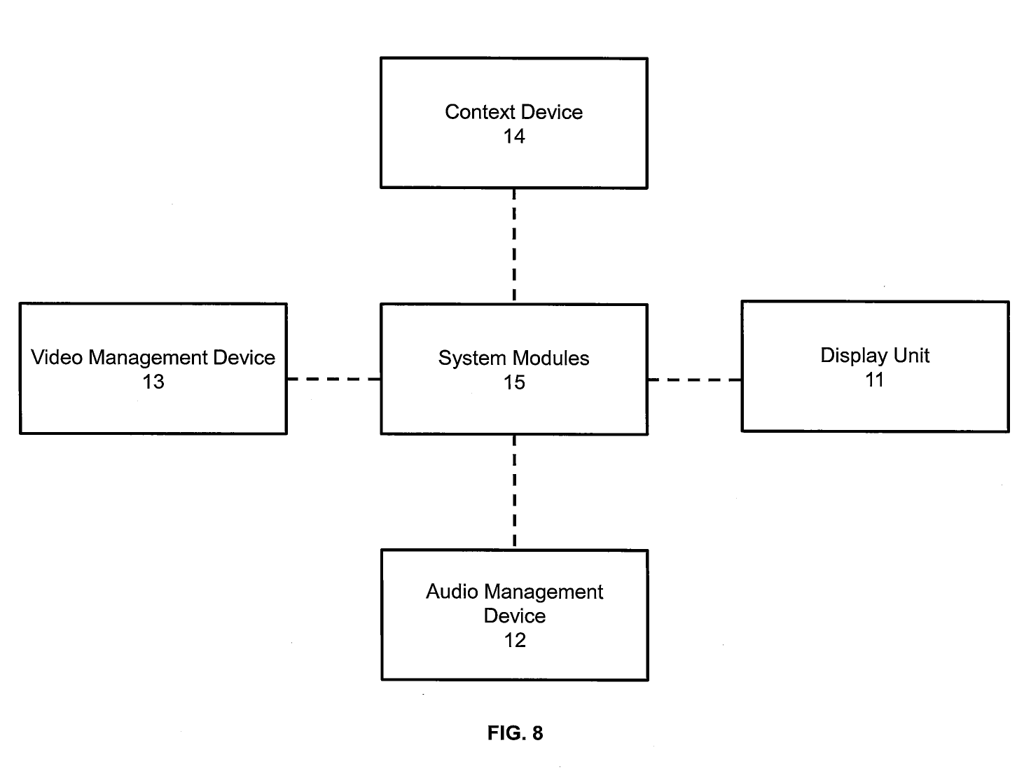

Embodiments of the present invention also may be configured to communicate with physical devices, as illustrated in FIG. 8. A user interface may be configured for a specific type of display unit 11. For example, various modules may be configured to communicate with a context device 12, such as a global positioning unit, configured to provide information such as location or reference point of the user or a clock. Various modules may be configured to communicate with an audio management device 13 may be configured to capture and communicate sounds or sound recordings. Various modules may be configured to communicate with a video management device 14 configured to capture and communicate audio-visual material such as audio-visual recordings

Certain embodiments of the present invention a user interface 400 configured to permit a user to access the system modules 12. A user interface may include a selective access element that permits control over access to the modules. The selective access element may require a user to provide certain personal information and create a user name and password in order to gain access to the system modules. An administrative user may have the right to make certain changes to the system that a non-administrative user would not have. In other embodiments, at least certain modules are accessible through a user interface without providing personal information or signing in.

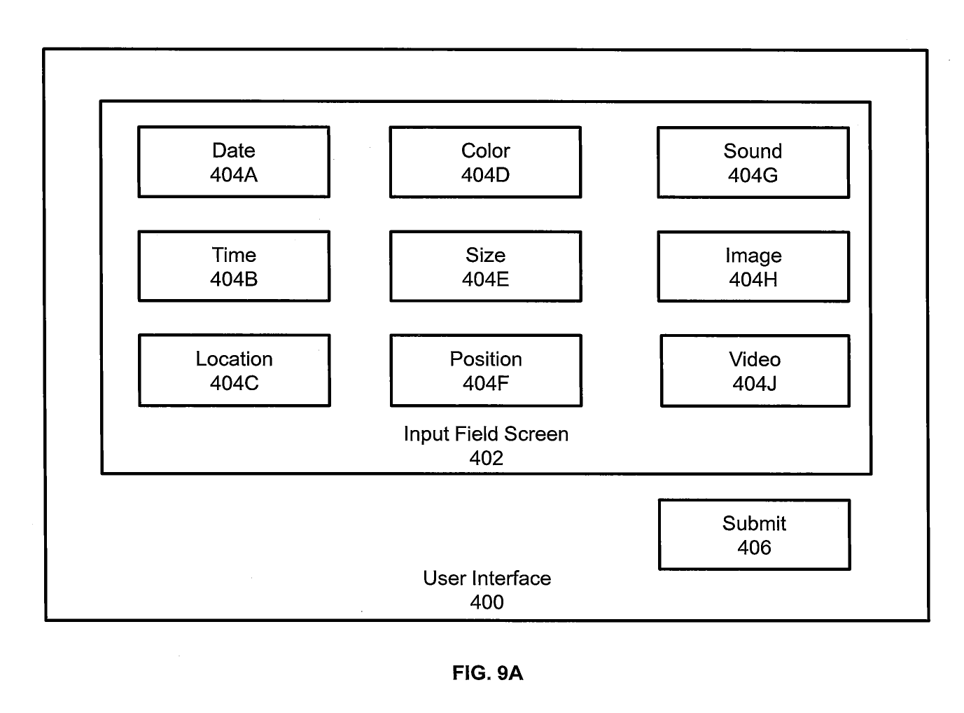

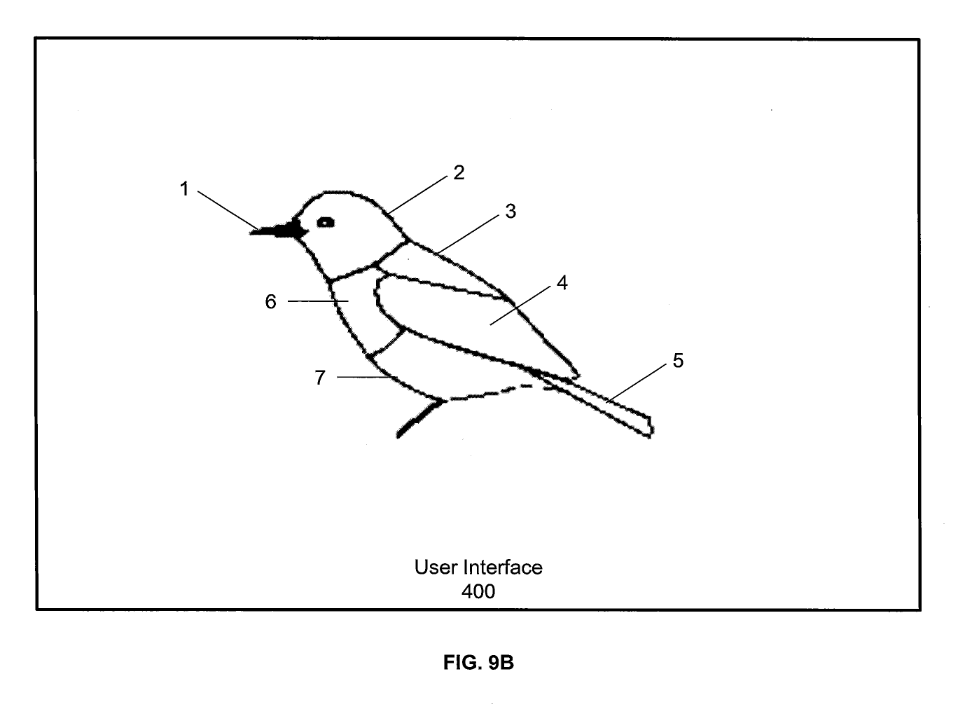

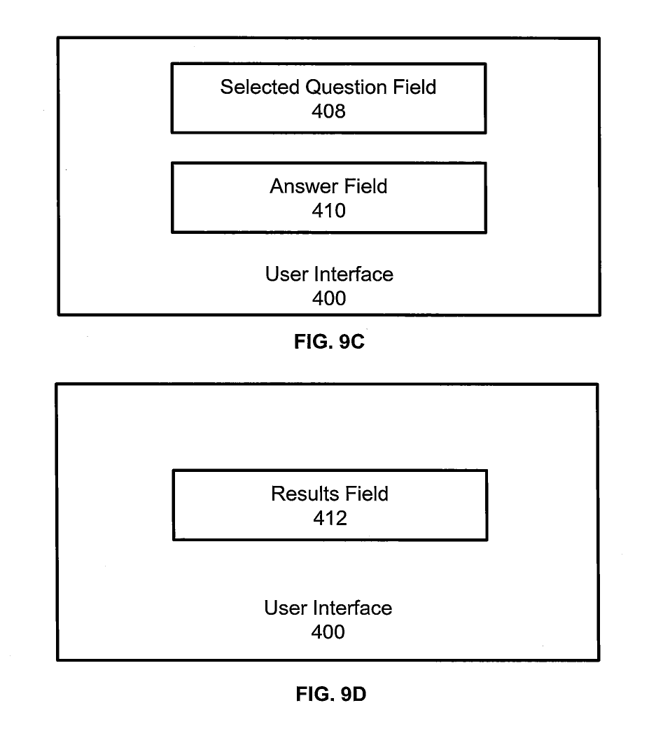

Embodiments of the user interface are illustrated in FIGS. 9 through 11. FIG. 9 illustrates an embodiment of a screen of input fields 402 in the user interface 400. The input field screen 402 may be configured to permit a user to enter freeform initial request information, or may identify certain characteristics for the user to input. An input field screen 402 may include a date field 404A, a time field 404B, a location field 404C, a color field 404D, a size field, 404E, a position field 404F, a sound recording field 404G, an image field 404H, and a video field 404J. Certain fields, such as the date field 404A, time field 404B, and location field 404C may be automatically populated by a context device (e.g., global positioning system, clock, calendar, etc.) or may be populated by the user. Although many input fields 404 are illustrated in one input field screen 402 in FIG. 9A, in other embodiments, each field 404 may be presented on a single screen or multiple fields may be included in each screen. Also, certain embodiments include, for example, only a color field 404D or only a size field 404E.

In certain embodiments, the color field 404D includes a number of sub-parts that permit the user to input color for each sub-part. To help a user identify each sub-part, the user interface 400 may include a labeled representation of a bird as illustrated in FIG. 9B. The representation may include labels for the bird's bill 1, head 2, back 3, wing 4, tail 5, breast 6, or belly 7.

After the user provides the input information by, for example, activating the submit function 406, the system assesses such information and may generate a follow-up question. The follow-up question may be displayed in a selected question field 408. The user may provide answer information in an answer field 410, as illustrated in FIG. 9C.

The system may generate multiple follow-up questions. Then, as illustrated in FIG. 9D, the system will produce a result in the results field 412. The results may include text, image, sound recording, or video recording regarding one or more possible bird species results. In certain embodiments, the results include a list of bird species results that are ranked by likelihood of being true based on the user-provided information.

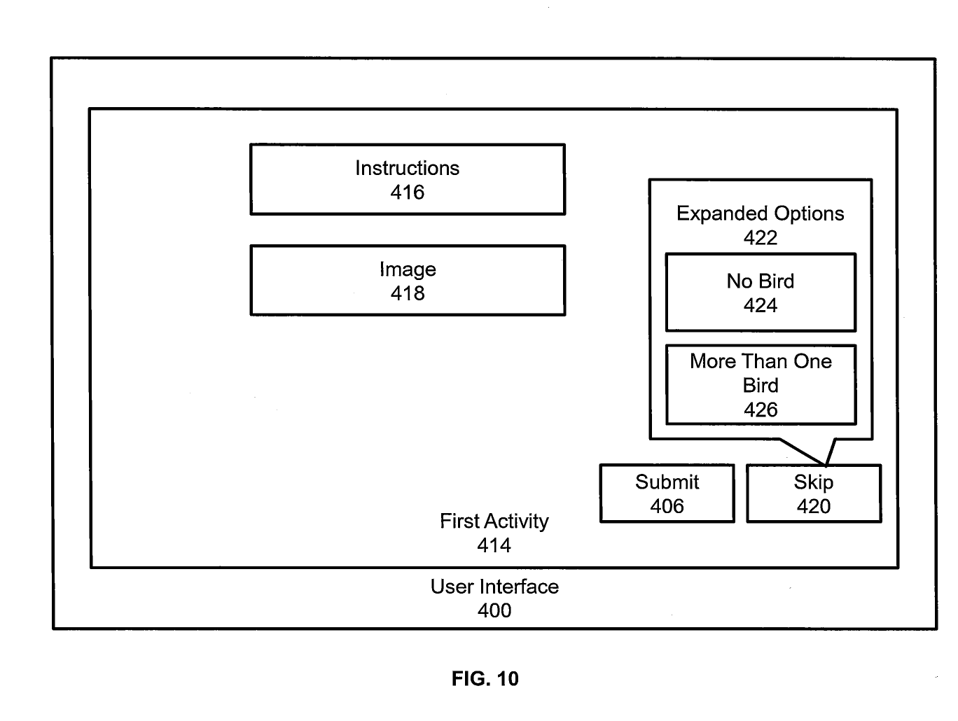

FIG. 10 illustrates an embodiment of a first activity 414 in a user interface 400. One embodiment may include instructions 416, for example, for cropping an image 418 of a bird. The user may be asked to use a cropping tool to crop the image down to the entire bird or a part of the bird. Such cropping activity permits the system to learn how to automatically identify and otherwise evaluate an image of a bird. The user may select the submit 406 or skip 420. Activating the skip function 420 may cause expanded options 422 to appear. The expanded options may include indicating that no bird was in the image 424 or more than one bird was in the image 426. The images may come from user uploads in other modules, so the image may not be reviewed by an administrator before entering the activity.

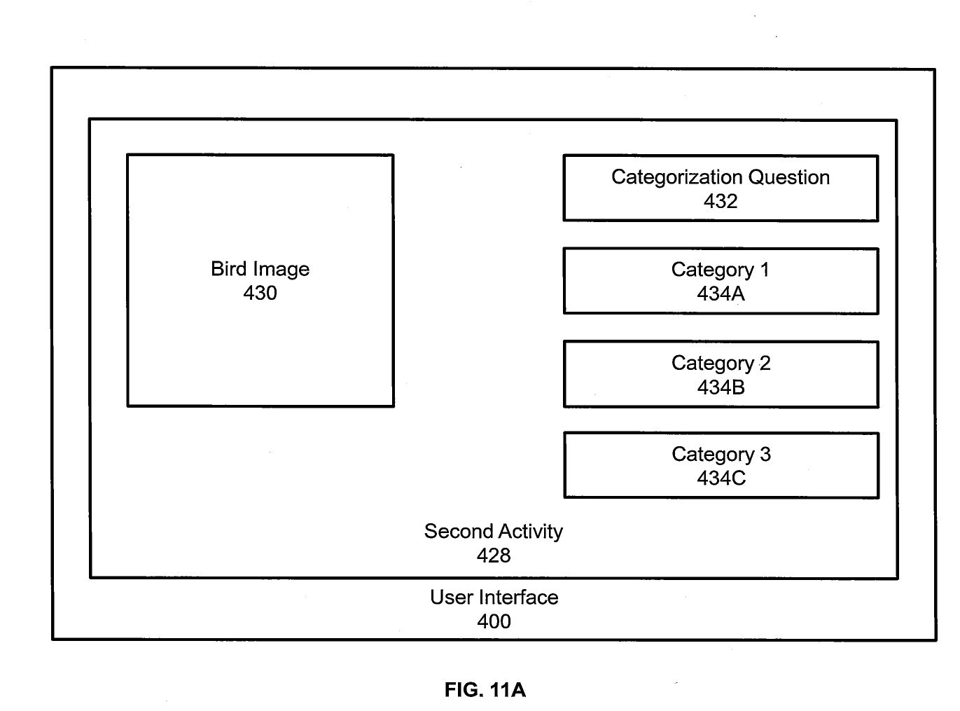

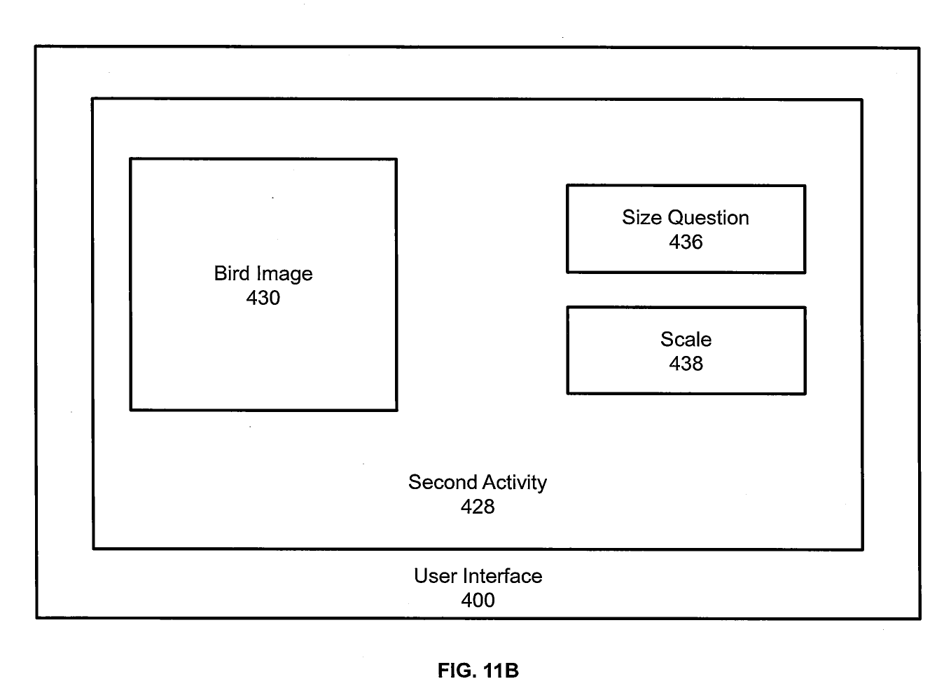

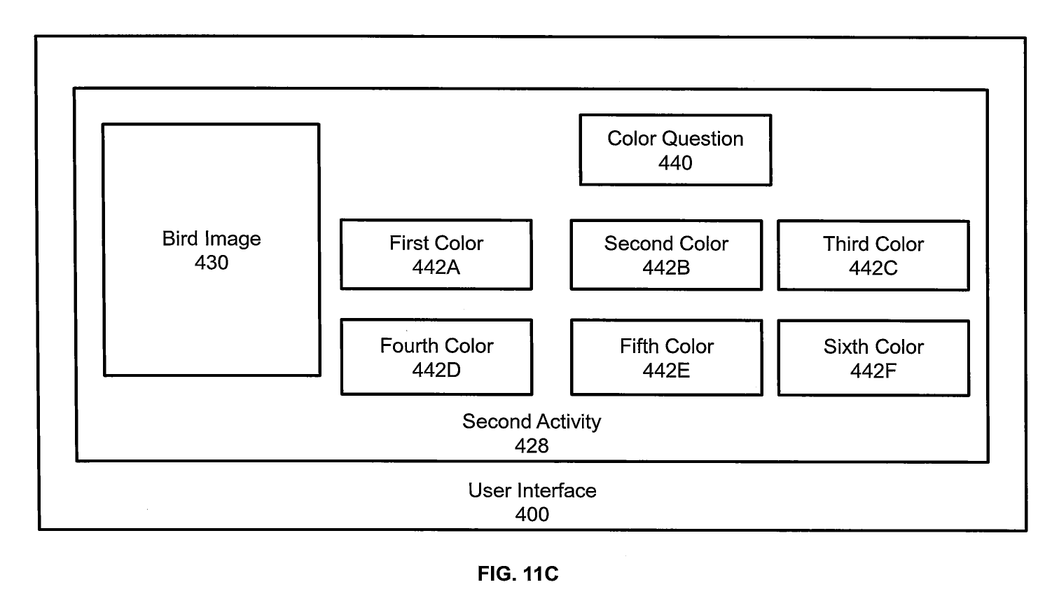

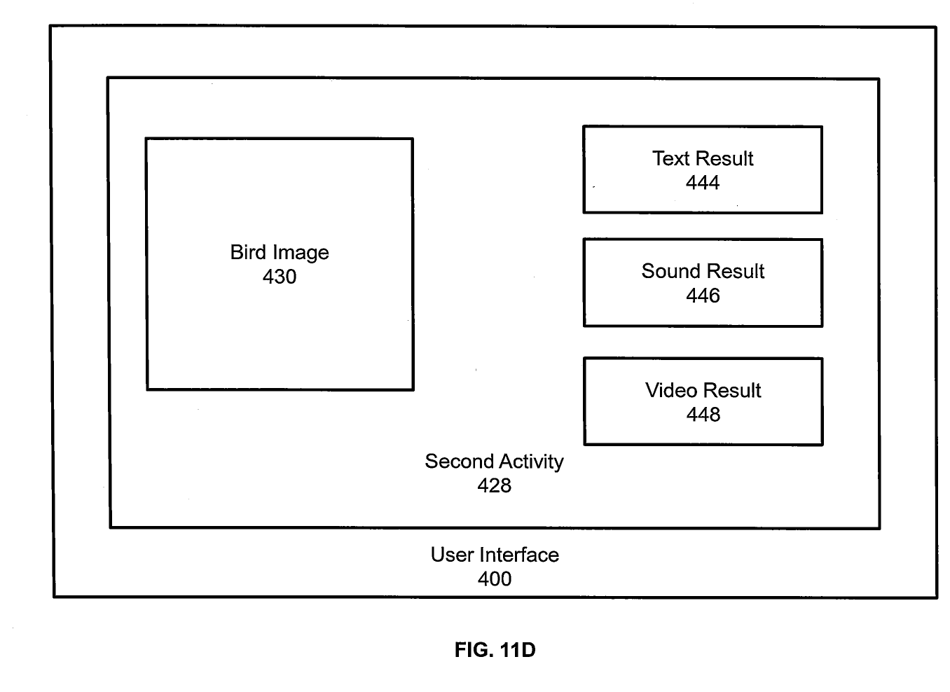

An embodiment of a second activity 428 is illustrated in a user interface 400 in FIG. 11A. The second activity 428 may be configured to assist the system in learning how users of various skill levels and various other backgrounds perceive a bird image 430. In such activity, a first screen may include a categorization question 432 with multiple categories 434, such as songbird, waterbird, hawks and owls, or grouse and quail. Each category may have a rollover function such that upon activating such function, additional details about the category is displayed.

Another screen in the second activity 428 may include a size question 436 and a scale 428, as illustrated in FIG. 11B. The scale may permit the user to select an option among various well-known birds. Similarly, as illustrated in FIG. 11C, a color question 440 may be presented. The user may select from various color options 442.

Then, the results screen of the second activity 428 may be displayed. Such screen may include a text result 444, sound result 446, or video result 448.

Additional attributes and embodiments of the systems and methods according to the present invention are described below.

A system according to the present invention may integrate with different bird websites. The system may be designed to be broadly adapted across a spectrum of formal and informal science education environments, including exhibits, mobile devices, homeschooling kits, social networking sites, and electronic field guides.

The system may increase user skills in observation, identification, and classification; increase user knowledge of bird diversity and lifestyles; and engage more users in exploring information about birds, sharing the information with others, and participating in citizen-science projects. The system may track online behaviors and outcomes expressed through scores in bird identification games and other social networking activities.

The system uses the information from users, and their confirmation or rejection of final bird identifications, to become more accurate and comprehensive with each question and answer session conducted by users. Training data may include descriptors from expert sources, as well as crowd sourced submissions. The system may use data from citizen-science database such as eBird to determine species unlikely to be in any particular location during any specific time of year to determine the most likely species within the database.

An example of a question and answer session when a user uses the system follows. (The system may permit users to use drop-down menus or add comments.)

The system: In what town, county, or state did you see the bird? User: New Mexico.
The system: OK. About 471 birds are reported in New Mexico, according to the eBird website. Use the drop-down menu to indicate what day, month, or time of year that you saw it. User: Winter.
The system: About 208 species are reported in New Mexico at that time of year. Use the drop-down list to select the location where you saw it. User: Yard.
The system: Was the bird at a feeder? User: Yes. [Comment: It loves sunflower seeds.]
The system: Was it larger/smaller/about the same size as an American Robin? User: About the same size.
The system: What color was it? Choose up to three from the list. User: Yellow, brown, black.
The system: Was the bird mostly yellow? User: Yes.
The system: Did the bird's head have a noticeable black cap? User: No.
The system: If you had said, yes, I might have guessed a male American Goldfinch. It could be a Western Meadowlark, but they usually eat on the ground, not at feeders. Did the bird have a pink bill? User: Don't know. [Comment: It was kind of pink or whitish.]
The system: Was this your bird? [The system shows image of Evening Grosbeak.
Below it, the system also displays “similar species” American Goldfinch and Western Meadowlark] User: Yes. [Comment: OMG!!! HOW DID YOU KNOW?]
The system: Congratulations, you've identified an Evening Grosbeak! Add it to your list on eBird. Explore sounds, photos, videos, and more information about Evening Grosbeak.
The system: Previous users agreed with you on the following attributes of this bird: 92% say yellow; 75% say American Robin-sized; 48% say seen at feeders. Previous users also noted the following attributes: 65% say very large bill; 46% say black wings.
The system: Since 1988, Project FeederWatch has documented a 50% decrease in the number of sites reporting Evening Grosbeaks. Join FeederWatch to keep track of grosbeaks and other birds.
The system: Keep playing! According to eBird records, Northern Flicker, Say's Phoebe, Mountain Chickadee, and 48 other species are commonly reported in New Mexico at this time of year. Would you like to practice identifying these birds? Go.

The system may incorporate activities/games by having a user paired with other real-time users or with a simulation if no other user is available. Users may view or hear the same bird photo, video, or sound. They type words to describe it or answer questions posed by the computer. Users receive points for picking the same words as others (this discourages “cheating” or entering bogus information). When time is up (e.g., after 30 seconds), users can guess what the bird is or click “pass.” The correct choice shows and users who have guessed the right answer receive bonus points. At times, an image may appear only briefly so users must rely on recall.

At the end of a round of play in a game, users can see a “recap” of the images they viewed, their guesses, and the correct IDs. They can click on any species to learn more from the Online Bird Guide or play another round. At any time, users can view their personal page where they can access all the photos they have seen while playing games, along with their guesses, correct answers, and scores. Users can challenge themselves by playing a quiz with images of birds they initially missed. Behind the scenes, descriptors from bird websites used as the training data the system needs to communicate with users.

The system also may use simpler games in which the user views a photo or video of a particular bird species and answers questions about attributes or characteristics such as color, shape, and behavior. Additional games, in which the user listens to a sound recording and answers questions describing attributes of the sound such as the pitch and pattern of the notes or other characteristics related to the sound, such as the location where the sound was heard.

The games may use scoring and recognition systems to motivate users. Users earn points for effort and accuracy, and can view their scores and cumulative totals as well as a public leader board. Users may earn “badges” or advance to new levels as they gain points. By analyzing users' activities and scores, the system may assess skills and knowledge of users.

A single-player game may be used by the system to guess the name of a bird or multiple-choice questions based on images, sounds, or videos. Users can select from a variety of themes and levels of difficulty. At the end, users can review their answers, the correct answers, and explore direct links to more information. Users can replay the same quiz or try a new one.

In one embodiment of the system, users may upload an image, video or sound of an unfamiliar bird to a Mystery Bird gallery where others can vote on the bird's identity. Users can post questions or comments about why they think the identifications of specific birds in the Mystery Bird gallery are right or wrong, or “flag” controversial images, videos, or sounds to request comments from experts. These images, videos, and sounds also may be used in other games with answers provided as percentage votes rather than an expert's identification.

The system may also generate a personal page for any user with a gallery of all bird images played in games, original answers, correct answers, and scores. The system may provide access to existing media resources that include bird species profiles with information, sound, video, identification tips, and natural history information.

The system may also evaluate itself by calculating statistics about how much information is obtained through crowd sourced submissions and how its identification method has improved by learning about how a wide variety of bird-watchers, e.g., experts and non-experts, describe certain characteristics of a bird. After asking a series of selected questions, in which each subsequent question is based on the likelihood of narrowing the field, the system may provide statistics regarding how many questions it typically asks before providing the user with a ranked list of possible species. It may also provide statistics about common inaccuracies between expert and non-expert submissions.

The system also may create application programming interfaces (APIs) to bring games of the system to other websites, social networking sites, and mobile devices. The system may offer tools so users can easily display their activities or achievements on social networking pages. These features might include “badges” reflecting skill level, the ability to display and vote on photos of mystery birds, posting a personal bird list, or notifying friends when a new bird has been identified. The system may be designed to record and display data on individual users' scores and activities.

As users become familiar with more birds, they also increase their knowledge of avian taxonomy and can learn to organize birds into biologically meaningful groups, such as ducks, raptors, and songbirds, a useful skill in identification. The system may facilitate users gaining skills in observation and description. By interacting with the system, users learn about the importance of these observations as general identification skills and strategies, including the importance of noticing when, where, and in what habitat they observed birds, as well as attributes such as shape, size, color, field marks, song, and other behaviors.

The system further may allow users to increase their skills and knowledge related to identification challenges, such as female birds, juveniles, shorebirds, regional birds, silhouettes, sounds, etc. Users can view controversial species, respond whether they agree with the majority opinion, and view other resources on other websites to determine their opinion.

The system may track users' skills as they play games and conduct question and answer sessions. This information may include documenting the typical user experience with the system, including patterns of interaction with the system, amount of participation by users, content areas of greatest participation by the users, and user reactions to particular content areas. The system may randomly sample repeat users and track changes over time, looking for evidence of improved user skills.

The system can measure the degree to which participants share content and interest with friends based on post-use web-based questionnaires with focal groups, as well as by measuring their use of email tools (e.g., “share this”) or status updates (e.g., “post to Facebook®”).

Other machine learning algorithms may be applied, for example, sound analysis algorithms, computer vision algorithms for sound recordings, and computer vision algorithms for images and video recordings that process captured user information to match an uploaded image or video with known objects and generate queries to the user about attributes and characteristics of the object.

In one embodiment, the present system may ask users questions about a bird they have seen and uses each response from the user to generate the next question as well as an ultimate answer. The system may gather information from each user response and become sequentially better at determining correct answers by recording the information and using accumulated information to improve future queries and ultimate answers.

The query and answer sessions performed by the system and user can facilitate user learning. User responses to queries may provide information that users can use to identify birds in future sessions. For example, a user may focus on certain features of a bird that may facilitate identification of the bird based on queries asked in earlier sessions.

The database of the system is augmented by users through acquisition of crowd sourced submissions. The more information that the database stores about the characteristics of each bird species, stored as images, video, and/or sound recordings, or descriptions in the words of novice users, the more successful the system may be in providing an accurate answer to a query and answer session. For this reason, acquisition of crowd sourced submissions is a preferred way to gather information about different species of birds. A system collecting crowd sourced submissions allows users to contribute information that employees or experts have traditionally provided. Three examples of ways to obtain crowd sourced submissions are particularly relevant to the system: citizen-science projects, user uploads, and “games with a purpose”.

Citizen-science projects such as the “Great Backyard Bird Count” and “eBird” engage tens of thousands of bird watchers in reporting sightings, gathering vast amounts of crowd sourced submissions that would be difficult to obtain from smaller groups of scientists. The eBird project now receives one million bird observations per month from various locations. As the system asks users where and when they saw a bird, it can tap into eBird data to rapidly determine the most likely bird species, based on those that are most likely to be seen in any town or region during any week, month, or time of year.

In one embodiment, the system may use information from authoritative sources such as an online bird guide. However, the terms from these sources alone may be inadequate because novices and experts often use different words to describe the same birds. Table 1 below shows that of twenty-three informative words from an email message asking for help in identifying a bird, only three words matched those used to describe the same species in an online bird guide. (The answer was “Northern Flicker.”)

TABLE 1

| Description from email query | Description from online bird guide |
|---|---|
| Yard, wooded country setting | Open habitats near trees, including |
| | woodlands, edges, yards, and parks |
| 5-9 inches | 11-12 inches |
| Looks a bit like a grouse, only | Large brown woodpecker |
| smaller | |
| Red on back of head | Red crescent on the nape |
| Black stripe under neck and upper | Black bib on upper breast |
| chest | |
| Long beak | Slightly downcurved bill |
| Digs worms or grubs from lawn | Eats mainly ants and beetles |

Experts often can recognize similar meaning in different words and distinguish between descriptors that are useful from those that are unreliable. Crowd sourced submissions may provide the system with vocabulary for more readily determining a species of bird. In one embodiment, the system may generate crowd sourced submissions by asking users to play games with a purpose.

One embodiment of the system includes an interactive online bird-identification tool, including associated games, social networking tools, and media. The system may extend learning, namely, integrating online games, media, and social networking. The games of the system are focused on helping users to identify birds and connect them to more information. One skilled in the art will recognize that the games may be varied to help users identify any object. In one embodiment, the games may be integrated with the resources on a particular bird website. The system also may include social networking tools to engage the online community in identifying “Mystery Birds Photos and Sounds” and to allow users to share their activities and achievements on social networking platforms. The system may help users improve observational skills and explore more information. The system may motivate novice users to notice and understand the diversity of life.

The system may allow a user to learn morphology by familiarizing users with the different parts of a bird. Users may learn the importance of location, habitat, and time of year, which relate to ecology, phenology, and climate. The system may provide media and natural history information that users may explore to learn about the diversity of bird behaviors and lifestyles, and the relationship between form (such as bill size) and function (such as spearing fish or cracking seeds).

One advantage of the system is that it can be implemented as an online or mobile system accessible by users from all over the world. Accordingly, the potential exists to increase participation by orders of magnitude. Thus, the number of crowd sourced submissions available for use by the system may be augmented.

The accuracy of each user's input is desirable when storing crowd sourced submissions in the database of the system. Filters may assist in selecting appropriate crowd sourced submissions to be stored for future use in the system.

Because users may want to identify an unknown bird, the system may require new sources of information to learn the correct answer. In one embodiment, the system may use user feedback on the system's dialogues posted to a bird website. The system also may require new sets of questions for distinguishing among bird species that require a wide range of inputs. Finally, the system may be designed to explicitly deal with a large amount of uncertainty in descriptions of size, color pattern, etc. By designing new classification techniques that use crowd sourced submissions, the system may create a dynamic database to supply common words and reveal useful as well as misleading inputs that are stored in a dynamic database to identify birds. The system may track individual users' skill development as they play games and access the system. The system may further track whether social networking generates new users of the system.

The use of games with a purpose may amass information from the public that express vocabulary in lay terms which can be used to develop queries based on those lay terms. In most cases, these games may be used to aid in search engine efficiency by connecting lay terms with specific species of birds. The system may create an extended dynamic database of terms based on user inputs. Moreover, the crowd sourced submissions may be sorted based on personal information such that certain users can be identified by the system and provided with appropriate queries based on the user identification. For example, information stored in the system could be accessed to reveal the features of birds most commonly perceived and described by non-experts.

The described embodiments are to be considered in all respects only as illustrative and not restrictive, and the scope of the invention is not limited to the foregoing description. Those of skill in the art may recognize changes, substitutions, adaptations and other modifications that may nonetheless come within the scope of the invention and range of the invention.

What is claimed is:

1. A system for providing information regarding an object to one or more users, comprising:
a processor;
a main memory in communication with the processor via a communication infrastructure and storing instructions that, when executed by the processor, cause the processor to:
receive an initial request that includes initial request information regarding an unknown object from a first user;
assess the initial request from the first user;
ascertain probability that initial request information is directed to each of a number of known objects by comparing information about the number of known objects available in dynamically-updated information storage module and the initial request information;
determine an appropriate first follow-up question;
present the appropriate first follow-up question to the first user through user interface;
obtain answer information to the appropriate first follow-up question;
analyze the answer information to the appropriate first follow-up question and comparing the initial request information with information available in information storage module;
evaluate whether there is a match between the information available in information storage module and the initial request information provided by the first user;
if match meets match threshold, produce result to first user in user interface and reach end of steps;
if match does not meet match threshold, deliver a subsequent follow-up question to the user through the user interface;
repeat the analysis step and evaluation step with respect to answer for subsequent follow-up question until a match having a sufficient threshold is found or an upper limit of subsequent questions is reached.

2. The system of claim 1, wherein the stored instructions further cause the processor to:
store the initial request information and the answer information, which together forms user-provided information;
identify differences between the initial request information and the information available in information storage module; and
attempt to improvement process based on identified differences;
if any, apply process improvement upon obtaining a successive initial request from a second user.

3. A system for providing information regarding an object to one or more users, comprising:
a processor;
a main memory in communication with the processor via a communication infrastructure and storing instructions that, when executed by the processor, cause the processor to:
supply a first question to a first user for which the first user provides first answer information;
assess the first answer information;
ascertain probability that initial request information is directed to each of a number of known objects by comparing information about the number of known objects available in dynamically-updated information storage module and the initial request information;
determine an appropriate first follow-up question;
present the appropriate first follow-up question to the first user through user interface;
obtain second answer information to the appropriate first follow-up question;
analyze the second answer information to the appropriate first follow-up question and compare the second answer information with the information available in information storage module;
evaluate whether there is a match between the information available in information storage module and the second answer information provided by the first user;
if match meets match threshold, produce result to first user in user interface and reach an end step;
if match does not meet match threshold, deliver a subsequent follow-up question to the user through the user interface;
repeat the receive step, analysis step, and evaluation step with respect to answer for subsequent follow-up question until a match having a sufficient threshold is found or an upper limit of subsequent questions is reached.

4. The system of claim 3, wherein the stored instructions further cause the processor to:
store the first answer information and the second answer information, which together forms user-provided information;
identify differences between user-provided information and the information stored in information storage module; and
attempt to improvement process based on identified differences;
if any, apply process improvement upon obtaining a successive initial request from a second user.

5. The system of claim 1, further comprising:
a display unit;
a user interface configured to be displayed on the display unit.

6. The system of claim 1, further comprising a context device.

7. The system of claim 1, further comprising an audio management device.

8. The system of claim 1, further comprising a video management device.

9. A system for providing information regarding an object to one or more users, comprising:
one or more system modules, said one or more system modules comprising at least an information storage module configured to store information and an identification module configured to facilitate identification of an object;
a display unit; and
a user interface configured to be displayed on the display unit.

10. A system of claim 9, wherein said one or more system modules includes an activity module.

11. A system of claim 9, wherein said one or more system modules includes a submission module.

12. A system of claim 9, wherein said one or more system modules includes an export module.

13. A system of claim 9, wherein said one or more system modules includes a messaging module.

14. A system of claim 9, further comprising a context device configured to provide context such as location and time regarding the information gathering.

15. A system of claim 9, further comprising an audio management device configured to capture and analyze sound recordings and communicate said sound recordings to and from said one or more system modules.

16. A system of claim 9, further comprising a video management device configured to capture and analyze video recordings and communicate said video recordings to and from said one or more system modules.

17. A method for identifying an unknown object for a user, comprising the steps of:
providing information, wherein the information includes one or more characteristics about an unknown object;
assessing the information;
determining whether a question about an unknown characteristic or a set of known objects should be presented to the user through a user interface;
if a set of object examples to the user through the user interface is presented, the method reaches an end;
if a question about an unknown characteristic is presented, receiving an answer from the user regarding that characteristic;
evaluating the answer from the user; and
repeating the determining step until the method reaches an end or an upper limit of iterations has been completed.

18. The method of claim 17, wherein the determining step includes:
ranking a list of known objects;
computing an expected cost of scanning the list of known objects:
calculating a minimum cost characteristic;
comparing the minimum cost characteristic to the expected cost of scanning the list of known objects;
if the minimum cost characteristic is less than the expected cost of scanning the list of known objects, the question about an unknown characteristic is presented, and
if the minimum cost characteristic is more than the expected cost of scanning the list of known objects, the set of known objects is presented.

19. The method of claim 18, wherein the evaluating step further includes:
ranking a list of known objects;
computing an expected cost of scanning the list of known objects:
calculating a minimum cost characteristic;
comparing the minimum cost characteristic to the expected cost of scanning the list of known objects;
if the minimum cost characteristic is less than the expected cost of scanning the list of known objects, the question about an unknown characteristic is presented, and
if the minimum cost characteristic is more than the expected cost of scanning the list of known objects, the set of known objects is presented.

20. The method of claim 17, further comprising the steps of:
learning about common inconsistencies between content and format of list of known objects and user-provided information;
improving the determining step and evaluating step by correcting for the common inconsistencies between content and format of list of known objects and user-provided information.
